(19) United States
(12) Patent Application Publication
(10) Pub. No.: US 2016/0232344 A1
(43) Pub. Date: Aug. 11, 2016

(54) METHOD FOR RE-ADJUSTING APPLICATION PERMISSION AND USER TERMINAL FOR PERFORMING THE SAME METHOD

(71) Applicant: ELECTRONICS AND TELECOMMUNICATIONS RESEARCH INSTITUTE, Daejeon (KR)

(72) Inventor: Bo-Heung CHUNG, Daejeon (KR)

(21) Appl. No.: 15/013,737

(22) Filed: Feb. 2, 2016

(30) Foreign Application Priority Data
Feb. 11, 2015 (KR) 10-2015-0021168

(51) Int. Cl. G06F 21/44; G06F 21/62

(52) U.S. Cl. CPC G06F 21/44; G06F 21/629

(57) ABSTRACT

The present disclosure relates to a user terminal and a method for automatically readjusting application permission. The user terminal comprises an application permission DB configured to store a permission list for applications installed in a user terminal; and an application permission dynamic regulator configured to regulate a permission list of a second application in order to prevent a first application from accessing to a component which the first application is not authorized by using the permission authorized to the second application when the first application execution is requested.

### CROSS REFERENCE TO RELATED APPLICATION

This application claims the benefit of Korean Patent Application No. 10-2015-0021168, filed on Feb. 11, 2015, entitled “Method for Re-adjusting Application Permission and User terminal for performing the same Method”, which is hereby incorporated by reference in its entirety into this application.

### TECHNICAL FIELD

Exemplary embodiments of the present disclosure relate to a technology for enhancing security in a user terminal operating system. More particularly, the present disclosure relates to a device and a method for providing an environment where applications can be executed securely in a user terminal by dynamically blocking applications from being executed of which permissions, which are not authorized by a user, are obtained illegally.

### BACKGROUND

Recently, user devices such as smartphones, smartpads and the like have been propagated rapidly. Various applications for users to manage important information such as personal information, financial transaction information and the like by using their devices have been provided in response to the propagation of such user devices. On the other hand, malicious programs have also increased rapidly to gather personal sensitive information or use them maliciously. Particularly, secondary damages due to loss on financial assets, personal information leakage and the like through malicious codes have overtaken those associated with the conventional PC environment.

Therefore, a method for executing applications safely and securely is highly demanded for users. That is, a secure execution environment should be provided to control illegal privilege escalation so that any malicious application program cannot be operated through the privilege escalation which gains elevated access to resources that are normally protected from an application.

### SUMMARY

An object of the present disclosure is to provide a technology for a user to execute applications (e.g., various financial transaction applications such as a banking App and a stock App), which require high degree of security, safely in a user terminal operating system.

The present disclosure is to provide a method for verifying permission(s) requested during installation of an application, supporting to install the application with normal permission(s), and blocking execution of the application of which authorization is achieved through a ‘privilege escalation’ process by an unauthorized permission in order to provide secure execution of a desired application in a user terminal.

According to the present disclosure, there is provided a user terminal including: an application permission DB configured to store a permission list for applications installed in a user terminal; and when a first application execution is requested, an application permission dynamic regulator configured to regulate a permission list of a second application in order to prevent the first application from accessing to a component which the first application is not authorized by using the permission authorized to the second application.

The second application may be an application which is currently running in the user terminal.

The application permission dynamic regulator may delete a part of permissions in the permission list of the second application based on a permission list of the first application.

The application permission dynamic regulator may recover the deleted permissions in the permission list of the second application when the execution of the first application is completed.

The user terminal may further include an application permission manager configured to determine whether a permission is needed to execute the application.

The application permission manager may be located in the user terminal or in an external server.

The application permission dynamic regulator may question whether to allow a permission list of an application, which is requested to install in or update, to the application permission manager, and delete a permission which is unnecessary to execute the application from the permission list based on the result.

The permission list of the application of which the part of permissions is deleted may be reflected to the application permission DB.

The application permission manager may figure a permission, which is necessary to execute the application from the permissions included in the permission list, to transmit it to the application permission dynamic regulator when the request whether to allow a permission list of the application requested to install or update is received from the application permission dynamic regulator.

According to an embodiment of the present disclosure, there is provided a method for re-adjusting application permission in which applications are installed in a user terminal may include recognizing a request for executing a first application; and adjusting a permission list of a second application in order to prevent the first application from accessing to a component which the first application is not authorized by using the permission authorized to the second application.

According to an embodiment of the present disclosure, a method for automatically re-adjusting application permission is able to provide an environment in which a user executes an application securely without figuring authenticity of permission which is required to install the application in his/her terminal. More particularly, the method for re-adjusting application permission of the present disclosure allows to execute an application such as banking application, pay application and the like, which requires security, securely even in an environment where malicious codes are installed and operated to achieve illegal authorization through privilege escalation. That is, the present disclosure allows to fundamentally eliminate any chance of user's important information (password, account information) being leaked from a user terminal through a malicious application execution and further provides effective security through this to a user terminal which is rated as weak in security.

### BRIEF DESCRIPTION OF THE DRAWINGS

FIG. 1A and FIG. 1B are an example illustrating problems associated with a permission system of a conventional user terminal.

FIG. 2A and FIG. 2B illustrate concept for readjusting application permission according to an embodiment of the present disclosure.

FIG. 3 illustrates internal configuration of a user terminal according to an embodiment of the present disclosure in which an application permission dynamic regulator is implemented.

FIG. 4 illustrates a process for readjusting application permission according to an embodiment of the present disclosure during executing an application.

FIG. 5 illustrates a process for readjusting application permission according to an embodiment of the present disclosure when a request to install or update an application is made.

### DETAILED DESCRIPTION

While the present disclosure has been described with reference to particular embodiments, it is to be appreciated that various changes and modifications may be made by those skilled in the art without departing from the spirit and scope of the present disclosure, as defined by the appended claims and their equivalents.

Throughout the description of the present disclosure, when describing a certain technology is determined to evade the point of the present disclosure, the pertinent detailed description will be omitted.

Unless clearly used otherwise, expressions in the singular number include a plural meaning.

A current user terminal is authorized by a user to provide an environment to execute various applications at the same time and install such applications. However, there is no way for a user to determine accuracy and necessity of a permission list which is required to install an application in a user terminal. That is, when an application is installed in a current user terminal, a certain permission list (internet, access the SD card, SMS transmission and like) is requested to a user for authorization. However, the user cannot determine whether the requested permission is surely needed for application execution or not. For example, when an application developer (or provider) requests other permissions even though an internet permission is only needed, it is not easy for a user to verify the fact.

In addition, since authorization for an application is determined when it is installed in a current user terminal, when a malicious code obtains authorization for the application, which is actually not permitted, after the application is installed, the application can be executed without any verification process. Particularly, when authorization for the application is obtained through a ‘privilege escalation’ process under the situation that any change in authorization for the application is not made, there is no way to detect or block this.

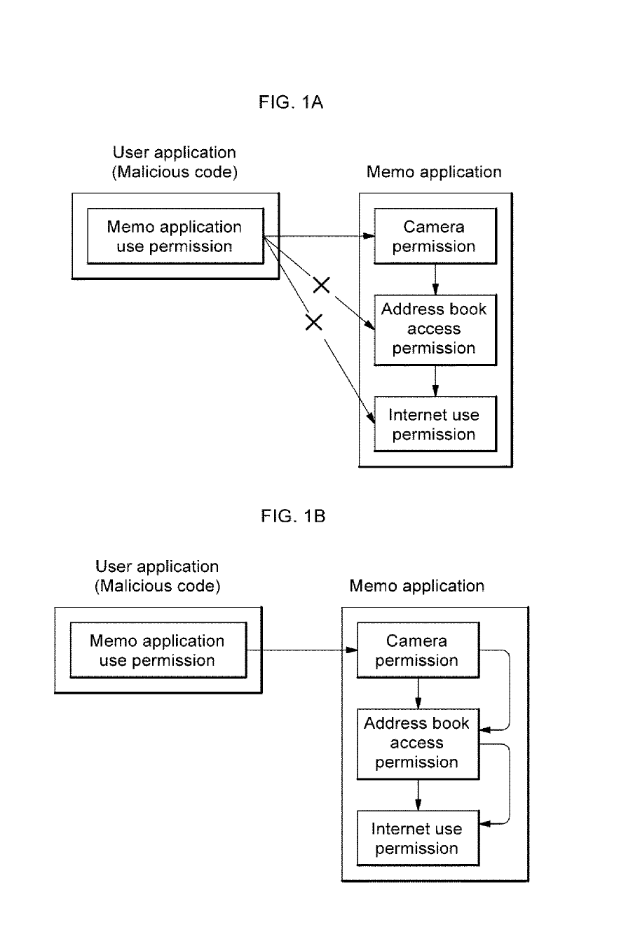

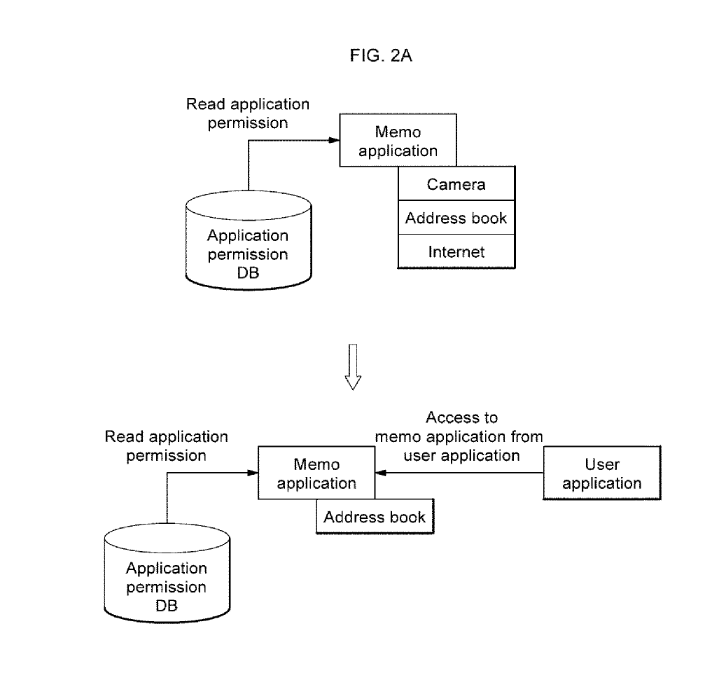

FIG. 1A and FIG. 1B are an example illustrating problems associated with a permission system of a conventional user terminal. Here, since a memo application is an example, all applications in a user terminal may be used as an application for privilege escalation and a user application may also include a program which is executed for malicious purposes such a malicious code.

Referring to FIG. 1A, permissions which are not allowed during installation of an application in a user terminal environment can be obtained dynamically during execution. The user application is assigned for a camera permission through a use permission, but not for an address book access permission and an internet use permission of the memo application when being installed. Thus, API cannot be directly called to use the address book access permission and the internet use permission of the memo application from the user application.

However, referring to FIG. 1B, the user application does not directly access to components, use the address book access permission and the internet use permission, of the memo application, but indirectly access to the components, which are not authorized, through the camera permission authorized to the user application. As a result, permissions which are not authorized can be also used. That is, the application can be developed to a plurality of components and these components can be developed to access internally to use each of features so that it causes a problem of that the application, which has permission for these components, can automatically obtain permissions for other components.

Therefore, it is demanded for a method for automatically eliminating permissions authorized regardless of application execution. In a conventional permission management, a user should define rules to control permissions of an application and reflects them to his/her terminal. However, it is practically impossible for the user to define rules and even it is not easy to understand the rules.

Monitoring in real time that an application modifies its own permissions or permissions of another application may cause performance load and complexity of a user terminal since the application should be involved in many parts in a user terminal system. In addition, a user should have pressure to approve it during this process. Accordingly, a method which is able to execute applications safely and securely with eliminating user's involvement is highly needed.

The conventional methods monitor and analyze illegal authorization changes without particular rules when they are installed or updated. On the other hand, a method of the present disclosure blocks obtaining authorization illegally without explicit authorization changes when applications are installed or updated.

That is, even though a malicious application is installed due to user's negligence or other factors, the present disclosure allows to execute applications securely all the time in an environment where right permissions are given through an “application permission manager” and an “application permission dynamic regulator”.

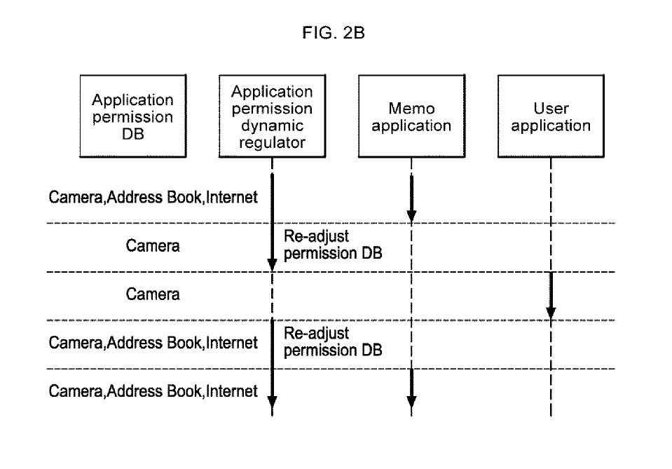

FIG. 2A and FIG. 2B illustrate concept for readjusting application permission according to an embodiment of the present disclosure.

Referring to FIG. 2A, when a user terminal executes only a memo application and other applications do not access to the memo application, the memo application may be executed with all the permissions which are originally authorized.

However, when the memo application is executed in the user terminal and a user application is executed and requests to access to a certain component of the memo application, the permission of the memo application only authorized to the user application, not all permissions, may be executed.

Referring to FIG. 2B, it is assumed that when the memo application is installed, permissions for a camera, an address book and an internet are authorized and installed, and the user application is installed with the permission only for the camera of the memo application.

When execution of the memo application is requested, an application permission dynamic regulator of the present disclosure may perform permission analysis of the memo application and may not perform permission modification when there is no problem. The memo application may be executed based on the permission stored in an application permission DB.

When the user terminal recognizes a request event of user application execution, the application permission dynamic regulator may analyze relationship between the memo application and the user application. When it is determined as that re-adjustment for the permission of the user application (e.g., when permission of the memo application is allowed more than a permission range of the user application), the application dynamic regulator may request to delete permissions for an address book and an internet of the memo application from the application permission DB to a user terminal operating system (e.g., Android). When the user terminal operating system completes this process, the user application may be allowed to be executed.

In addition, when the user application completes, a reverse process thereof may be performed. That is, the user terminal operating system may recover the deleted permissions in the application permission DB.

The present disclosure allows to be operated by being combined with software and hardware. The application permission dynamic regulator of the present disclosure may be implanted in a hardware-based device such as TPM/MTM and provide this in a hardware abstraction layer (HAL) form of the user terminal to ensure security from physical hacking attacks. Contents of the present disclosure may be easily applied in H/W form.

Hereinafter, the present disclosure will be explained in detail with reference to accompanying drawings.

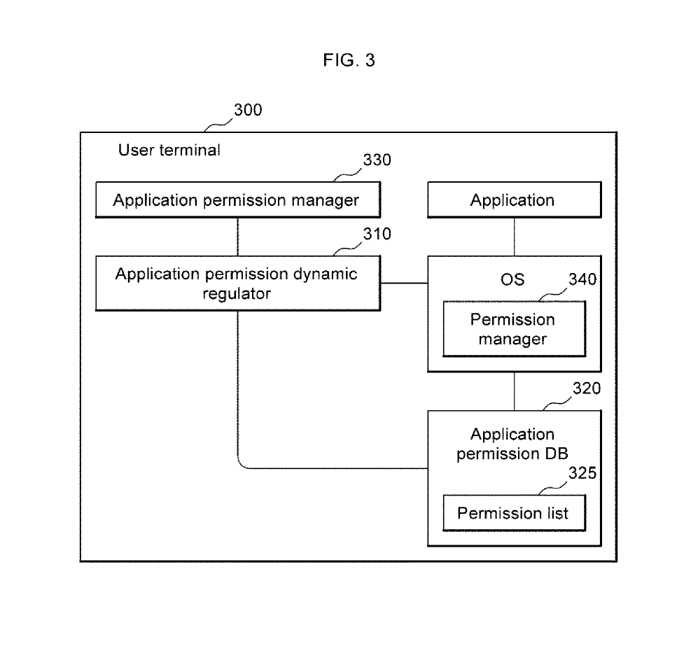

FIG. 3 illustrates internal configuration of a user terminal according to an embodiment of the present disclosure in which an application permission dynamic regulator is implemented.

Referring to FIG. 3, a user terminal 300 may include an application permission dynamic regulator 310, an application permission DB 320 and more than one application.

The user terminal 300 may further include an application permission manager 330.

Alternatively, the application permission manager 330 may be located in an external server.

The user terminal 300 may include various user devices such as a smartphone, a smartpad, a PDA, a WiBro terminal and the like, preferably a user device using a mobile terminal operating system (e.g., Android).

When execution of a first application is requested, the application permission dynamic regulator 310 may adjust a permission list of a second application in order to prevent the first application from accessing to a component, which is not authorized to the first application, by using the permission authorized to the second application. Here, the second application may be an application which is running in the user terminal 300. Explanation with a case that the second application which is running in the user terminal is one is provided herein but the present disclosure is not limited to this. It is to be appreciated that the present disclosure may include cases that the second application is more than one.

In an embodiment, the application permission dynamic regulator 310 may regulate to delete a part of permissions in a permission list of the second application stored in the application permission DB 320 based on a permission list of the first application directly or through a permission manager 340 in an operating system (OS) of the user terminal.

The application permission dynamic regulator 310 may also regulate to recover the deleted permission(s) from the permission list of the second application in the application permission DB 320 directly or through the permission manager 340 when execution of the first application is completed.

For example, it is assumed that the second application has authority for the first permission, the second permission and the third permission in the permission list and the first application only has authority for the first permission.

When execution of the first application is requested, the application permission dynamic regulator 310 may delete the second permission and the third permission, except the first permission, for which the first application has authority, from the permissions authorized to the second application.

Thus, even though the first application is executed, the first application has authority only for the first permission and the second application also has authority only for the first permission during the first application is executed. Thus, the first application may not have authority for the second permission and the third permission by using the permission authorized to the second application through ‘privilege escalation’.

When execution of the first application is completed, the application dynamic regulator 310 may recover the second permission and the third permission which have been deleted.

Furthermore, when an application is installed/updated, the application permission dynamic regulator 310 may request to the application permission manager 330 to determine whether a permission list 325 requested to install/update is normal or not. The application permission dynamic regulator 310 may delete permission(s) which is excessively given when the application is installed based on the result and then authorize to install/update the application in the user terminal 300.

The application permission dynamic regulator 310 may directly modify the application permission DB 320 or the permission manager 430 in the operating system (OS) of the user terminal 300 may detect changes in permissions and perform an operation to modify the application permission DB 320.

The application permission dynamic regulator 310 may operate when the user terminal 300 is operating and may not be stopped or deleted. Thus, the application permission dynamic regulator 310 may be installed in advance in the user terminal 300 as a built-in application.

The application permission DB 320 may include a permission list 325 for an application installed in the user terminal 300.

The application permission DB 320 may reflect information about the permissions, when they are changed, to the permission list 325.

The application permission manager 330 may find API which is needed to authorize an application permission to analyze the API and the requested permission list 325.

When there is a permission which is requested overly in the requested permission list, the application permission manager 330 may transmit the overly requested permission to the application permission dynamic regulator 310. The application permission dynamic regulator 310 may request to adjust the permission to the permission manager 340 or the application permission dynamic regulator 310 may directly modify the application permission DB 320. The user terminal 300 may also modify the application permission DB 320 through the permission manager 340.

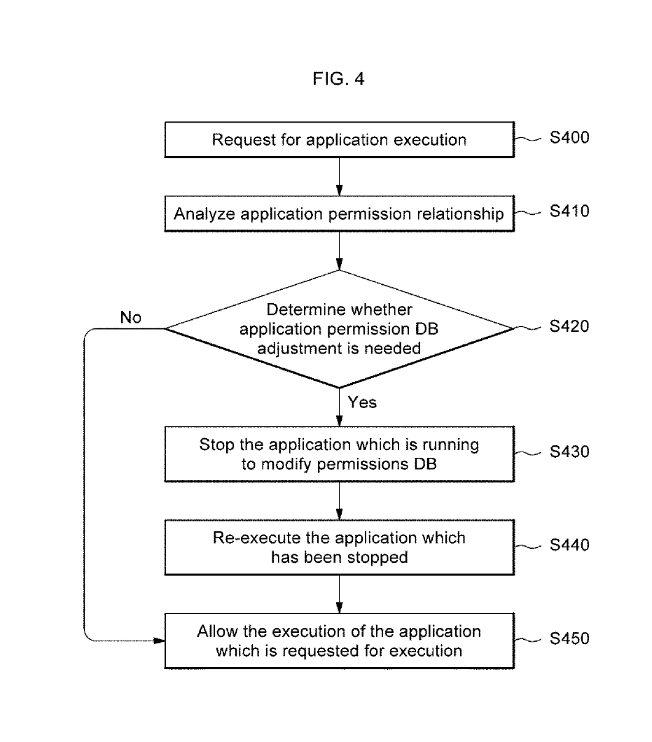

FIG. 4 illustrates a process for readjusting application permission according to an embodiment of the present disclosure during executing an application.

In S400, a user may request of application execution to a user terminal.

In S410, an application permission dynamic regulator may extract a permission list of the application from an application permission DB and compare permissions of the application which is requested for execution using the extracted permission list.

In S420, the application permission dynamic regulator may determine whether permission adjustment is needed or not based on the compared result.

In S430, when permission adjustment is needed, the user terminal may stop the application which is running to modify permissions of the executing application. Here, the case of that permission adjustment is needed is a case that the application permission dynamic regulator detects that an application which is requested to be executed is going to obtain permission which is not allowed by using authority of the application which is already running.

In S440, when the permission is modified, the user terminal may re-execute the application which has been stopped.

In S450, the user terminal may allow the execution of the application which is requested for execution since the permission is modified in a safe range. The permission manager in the operating system of the user terminal may store the modified permission information in the application permission DB.

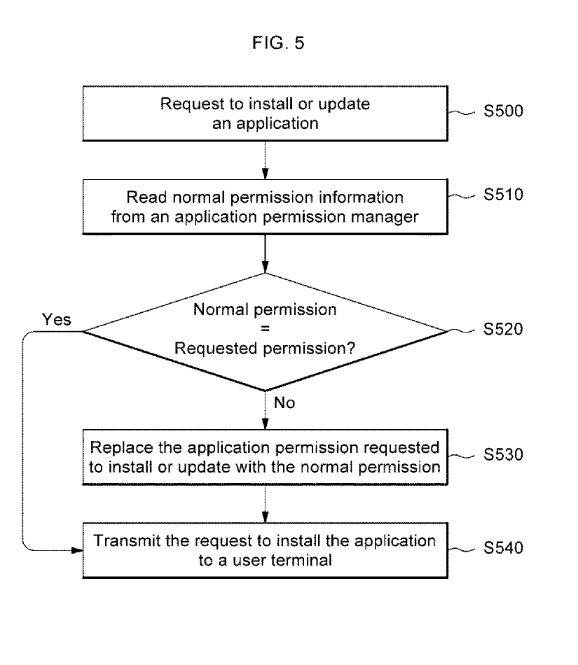

FIG. 5 illustrates a process for readjusting application permission according to an embodiment of the present disclosure when a request to install or update an application is made.

In S500, a user may request to install or update an application to a user terminal by clicking an installation or update button.

In S510, an application permission dynamic regulator may transmit a request of the application permission to install or update to an application permission manager and request to determine whether the permission is normal or not. The application permission dynamic regulator may receive that the permission information is normal from the application permission manager.

In S520, the application permission dynamic regulator may compare the received normal permission with the application permission information which is requested to install or update.

In S530, when the received normal permission is not identical to the application permission information (for example, when the application permission which is requested to install or update is overly requested), the application permission dynamic regulator may replace the application permission requested to install or update with the normal permission.

In S540, when it is replaced by the normal permission, the application permission dynamic regulator may request to install or update the application to the user terminal.

When the normal permission is identical to the application permission requested to install or update, the application permission dynamic regulator may request to install or update the application to the user terminal without modifying the permission. The user terminal may then install or update the application and store the modified permission information to the application permission DB.

Through this process, even though the user does not know a permission list of the application to be installed accurately, only needed permission can be installed so that it is able to eliminate installing an application with excessive permissions. Here, the permission list may be described in AndroidManifest.xml file when an application is installed. The AndroidManifest.xml file may include information about permissions such as internet connection, address book access, system access and the like.

The exemplary embodiment of the present disclosure can be implemented by the method which the computer is implemented or in non-volatile computer recording media stored in computer executable instructions. The computer readable medium may include a program instruction, a data file and a data structure or a combination of one or more of these.

The program instruction recorded in the computer readable medium may be specially designed for the present invention or generally known in the art to be available for use. Examples of the computer readable recording medium include a hardware device constructed to store and execute a program instruction, for example, magnetic media such as hard disks, floppy disks, and magnetic tapes, optical media such as CD-ROMs, and DVDs, and magneto-optical media such as floptical disks, read-only memories (ROMs), random access memories (RAMs), and flash memories. In addition, the above described medium may be a transmission medium such as light including a carrier wave transmitting a signal specifying a program instruction and a data structure, a metal line and a wave guide. The program instruction may include a machine code made by a compiler, and a high-level language executable by a computer through an interpreter.

The above described hardware device may be constructed to operate as one or more software modules to perform the operation of the present invention, and vice versa.

While it has been described with reference to particular embodiments, it is to be appreciated that various changes and modifications may be made by those skilled in the art without departing from the spirit and scope of the embodiment herein, as defined by the appended claims and their equivalents. Accordingly, examples described herein are only for explanation and there is no intention to limit the invention. The scope of the present invention should be interpreted by the following claims and it should be interpreted that all spirits equivalent to the following claims fall with the scope of the present invention.

### DESCRIPTION OF REFERENCE NUMERALS

300: User terminal
310: Application permission dynamic regulator
320: Application permission DB
330 Application permission manager

What is claimed is:

1. A user terminal comprising:
an application permission DB configured to store a permission list for applications installed in a user terminal; and
when a first application execution is requested, an application permission dynamic regulator configured to regulate a permission list of a second application in order to prevent the first application from accessing to a component which the first application is not authorized by using the permission authorized to the second application.

2. The user terminal of claim 1, wherein the second application is an application which is currently running in the user terminal.

3. The user terminal of claim 2, wherein the application permission dynamic regulator deletes a part of permissions in the permission list of the second application based on a permission list of the first application.

4. The user terminal of claim 3, wherein the application permission dynamic regulator recovers the deleted permissions in the permission list of the second application when the execution of the first application is completed.

5. The user terminal of claim 1, further comprising an application permission manager configured to determine whether a permission is needed to execute the application.

6. The user terminal of claim 5, wherein the application permission manager is located in the user terminal or in an external server.

7. The user terminal of claim 5, wherein the application permission dynamic regulator questions whether to allow a permission list of an application, which is requested to install in or update, to the application permission manager, and deletes a permission which is unnecessary to execute the application from the permission list based on the result.

8. The user terminal of claim 7, wherein the permission list of the application of which the part of permissions is deleted is reflected to the application permission DB.

9. The user terminal of claim 7, wherein the application permission manager figures a permission, which is necessary to execute the application from the permissions included in the permission list, to transmit it to the application permission dynamic regulator when the request whether to allow a permission list of the application requested to install or update is received from the application permission dynamic regulator.

10. A method for re-adjusting application permission in which applications are installed in a user terminal, the method comprising:
recognizing a request for executing a first application; and
adjusting a permission list of a second application in order to prevent the first application from accessing to a component which the first application is not authorized by using the permission authorized to the second application.

11. The method of claim 10, wherein the second application is an application which is currently running in the user terminal.

12. The method of claim 10, wherein the step for adjusting a permission list of a second application comprises deleting a part of permissions in the permission list of the second application based on a permission list of the first application.

13. The method of claim 12, further comprising recovering the deleted permissions from the permission list of the second application when the execution of the first application is completed.

14. The method of claim 10, further comprising:
recognizing a request for installing an application in the user terminal;
determining whether to allow a permission list of the application; and
adjusting the permission list of the application based on the determined result.

15. The method of claim 14, wherein the step for determining whether to allow a permission list of the application comprises:
figuring a permission which is necessary to execute the application by analyzing API of the application; and
deleting a permission which is unnecessary to execute the application from the permission list of the application.
